(19) United States
(12) Patent Application Publication
(10) Pub. No.: US 2015/0081929 A1
(43) Pub. Date: Mar. 19, 2015

(54) CONTROL CIRCUIT AND CONTROL METHOD FOR ADAPTIVELY ADJUSTING PARAMETER SETTING OF PCI-E DEVICE

(71) Applicant: Realtek Semiconductor Corp., HsinChu (TW)

(72) Inventors: Wen-Shan Wang, Tainan City (TW); Shih-Hung Wang, Miaoli County (TW)

(73) Assignee: Realtek Semiconductor Corp., HsinChu (TW)

(21) Appl. No.: 14/191,455

(22) Filed: Feb. 27, 2014

(30) Foreign Application Priority Data
Sep. 14, 2013 (TW) 102133323

(51) Int. Cl. G06F 13/10

(52) U.S. Cl. CPC G06F 13/10
USPC 710/8

(57) ABSTRACT

A control circuit for a peripheral component interconnect express (PCI-E) device includes a power detecting unit and a parameter adjustment unit. The power detecting unit is coupled to a wireless communication transmitter, and arranged to detect a spectrum intensity value of an output spectrum of the wireless communication transmitter. The parameter adjustment unit is coupled to the power detecting unit, and arranged to produce at least one control signal according to the spectrum intensity value and adaptively adjust a parameter setting of the PCI-E device in accordance with the at least one control signal.

### BACKGROUND OF THE INVENTION

1. Field of the Invention

The disclosed embodiments of the present invention relate to a control mechanism of a peripheral component interconnect express (PCI-E) device, and more particularly, to a control circuit for a PCI-E device which can reduce the wireless communication interference and a related control method.

2. Description of the Prior Art

The PCI-E device mainly operates at 1.25 GHz. Consequently, harmonics occur at frequencies each being an integer multiple of the main operation frequency, such as a second harmonic occurring at 2.5 GHz (i.e. 1.25 GHz*2).

The transmission band of the wireless fidelity (Wi-Fi), however, is also around 2.5 GHz. As a result, when the second harmonic is radiated or coupled to the transmission path of the Wi-Fi circuit through different paths, a spur may be introduced to the output spectrum of the Wi-Fi circuit at 2.5 GHz. Please refer to FIG. 1, which is a diagram illustrating an example of an output spectrum of a Wi-Fi circuit interfered by a PCI-E device. A dotted line 101 is used to indicate the upper bound specified by the electromagnetic interference (EMI) specification. As shown in FIG. 1, due to the interference produced by the PCI-E device, it can be seen that a surge which exceeds the dotted line 101 at 2.5 GHz leads to an EMI test failure.

Therefore, there is a need for a mechanism which is capable of reducing the second harmonic at 2.5 GHz introduced by a PCI-E device while maintaining the transmission quality of the PCI-E device.

### SUMMARY OF THE INVENTION

One of the objectives of the present invention is to provide a control circuit for a PCI-E device which can reduce the wireless communication interference and a related control method to solve the aforementioned issues.

According to a first embodiment of the present invention, a control circuit for a peripheral component interconnect express (PCI-E) device is disclosed. The control circuit comprises: a power detection unit and a parameter adjustment unit. The power detection unit is coupled to a wireless communication transmitter, and is arranged for detecting a spectrum intensity value of an output spectrum of the wireless communication transmitter. The parameter adjustment unit is coupled to the power detection unit, and is arranged for generating at least one control signal according to the spectrum intensity value, and adaptively adjusting a parameter setting of the PCI-E device according to the at least one control signal.

According to a second embodiment of the present invention, a control method for a peripheral component interconnect express (PCI-E) apparatus is disclosed. The control method comprises: detecting a spectrum intensity value of an output spectrum of the wireless communication transmitter; and generating at least one control signal according to the spectrum intensity value, and adaptively adjusting a parameter setting of the PCI-E device according to the at least one control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an example of an output spectrum of a Wi-Fi circuit interfered by a PCI-E device.

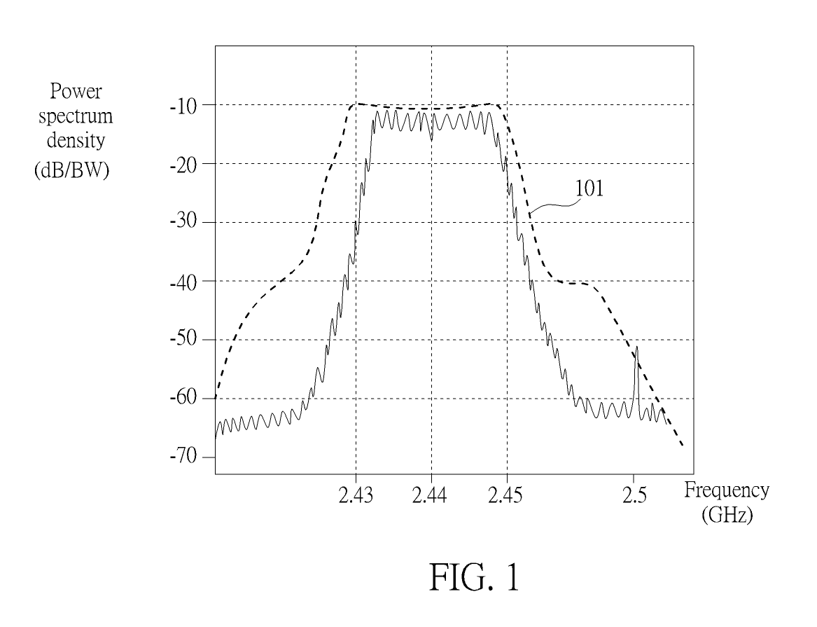

FIG. 2 is a diagram illustrating a control circuit applied for the PCI-E device according to an embodiment of the present invention.

FIG. 3 is a diagram illustrating the amplifier and the reference voltage generator shown in FIG. 2.

FIG. 4 is a flowchart illustrating a control method for a PCI-E device according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

The purpose of the present invention is to detect an interference signal (e.g. a surge) in an output spectrum of a wireless communication device (e.g. a wireless fidelity (Wi-Fi) circuit). When an interference signal is found exceeding an upper bound specified in an electromagnetic interference (EMI) specification, an on-chip parameter setting of a peripheral component interconnect express (PCI-E) device located around the wireless communication device will be dynamically adjusted. Accordingly, the radiance (signal intensity) of a second harmonic of the PCI-E device can be suppressed, thereby reducing the interference which is introduced to the transmission of the wireless communication device due to the second harmonic produced by the PCI-E device.

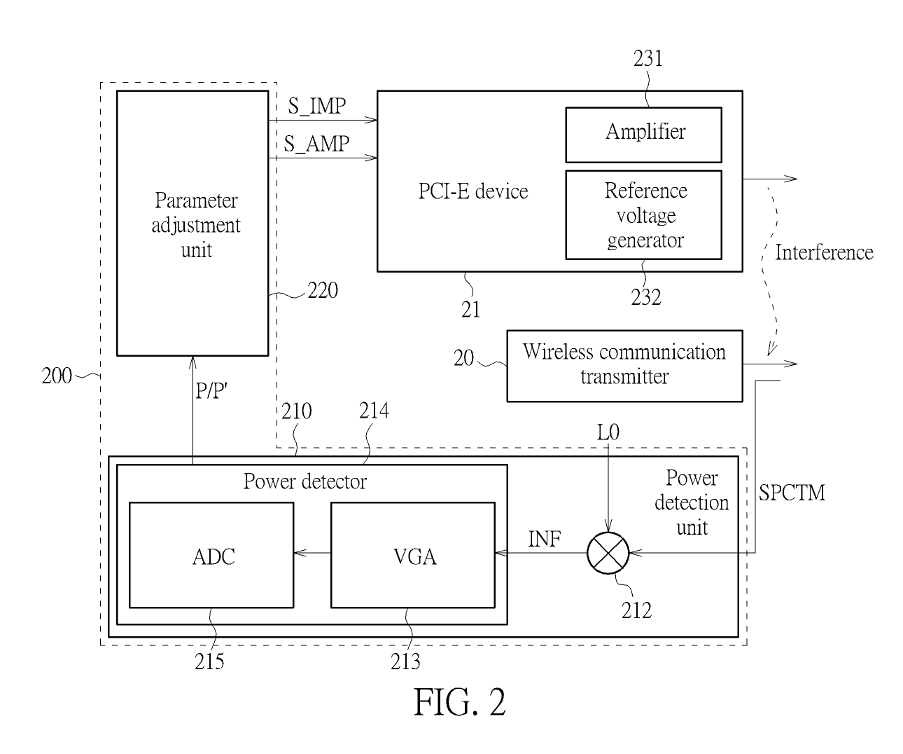

Please refer to FIG. 2, which is a diagram illustrating a control circuit applied to the PCI-E device according to an embodiment of the present invention. The control circuit 200 is coupled to a PCI-E device 21, and includes a power detection unit 210 and a parameter adjustment unit 220. The power detection unit 210 is coupled to a wireless communication transmitter 20. For example, the wireless communication transmitter 20 may be a Bluetooth (BT) transmitter, a Wi-Fi transmitter or any other transmitter which operates at a transmission band close to or covering the frequency of the second harmonic of the PCI-E device. The power detection unit 210 is utilized to detect interference in an output spectrum SPCTM of the wireless communication transmitter 20, such as a surge in the output spectrum SPCTM. The power detection unit 210 converts a detected interference signal INF to a characteristic parameter P, wherein the characteristic parameter P indicates the intensity of the detected interference signal INF. The parameter adjustment unit 220 is coupled to the power detection unit 210, and adaptively adjusts the parameter setting of the PCI-E device 21 according to the characteristic parameter P. For example, the parameter adjustment unit 220 compares the characteristic parameter P with the upper bound specified by the EMI specification. In this way, the detected interference signal INF is verified on a basis of the EMI specification. If the interference signal INF exceeds the upper bound specified in the EMI specification (i.e., the interference signal INF violates the EMI specification requirement), the parameter adjustment unit 220 will adjust the internal parameter setting of the PCI-E device 21 (such as parameters regarding amplitude, impedance, etc.) to suppress the intensity of the interference signal INF, thereby allowing the transmission signal produced by the wireless communication transmitter 20 to comply with the EMI specification.

Specifically, the power detection unit 210 includes a mixer 212 and a power detector 214. The mixer 212 is used to down convert the interference signal INF of the output spectrum SPCTM to a lower frequency, such as the baseband, thus allowing the characteristic parameter to be derived conveniently in the following stage. For example, the mixer 212 receives a local oscillation signal LO with an oscillation frequency close to or equal to the frequency of the interference signal INF (e.g. 2.5 GHz). Thus, the interference signal INF can be obtained at the baseband as a result of mixing the local oscillation signal LO and the output signal of the wireless communication transmitter 20. The power detector 214 is coupled to the mixer 212, and may include a variable gain amplifier (VGA) 213 and an analog-to-digital converter (ADC) 215. The VGA 213 is responsible for adaptively controlling a gain G of the down converted signal, so that the down converted signal remains within a reasonable signal intensity range which is appropriate for a voltage swing of the ADC 215. In this way, it will be guaranteed to be free from an undersized signal which leads to an identification failure due to low resolution or an oversized signal which leads to clipping distortion. The ADC 215 further converts the signal outputted from the VGA 213 to the characteristic parameter P. It should be noted that the combination of the VGA 213 and the ADC 215 is merely one of various embodiments of the present invention. Any other structure which can derive a desired spectrum intensity value by detecting a down converted interference signal (e.g. an analog detection result or a digital detection result) can also be utilized to implement the power detector 214. These alternative designs all fall within the scope of the present invention.

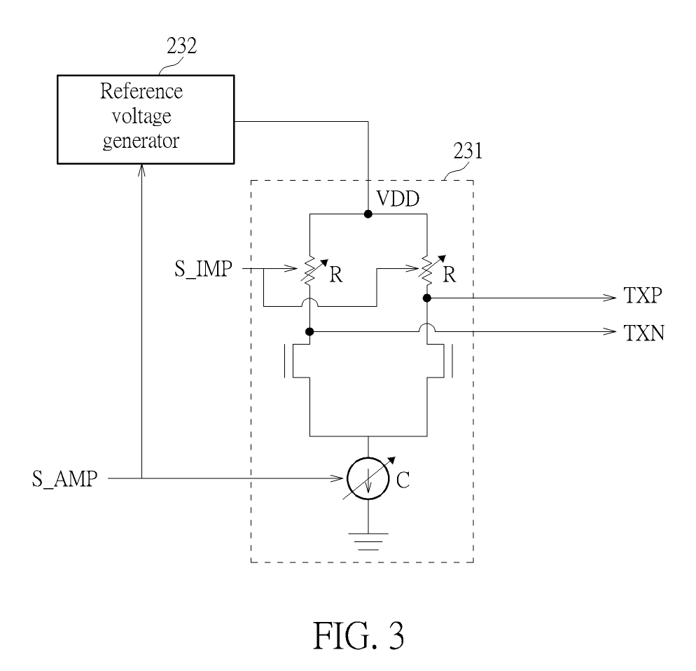

In addition, the parameter adjustment unit 220 compares the characteristic parameter P with the upper bound specified by the EMI specification, and accordingly produces at least a control signal to control the internal parameter setting of the PCI-E device 21. For example, the at least one control signal may include a first control signal S_IMP and/or a second control signal S_AMP, wherein the first control signal S_IMP is used to adjust an internal impedance parameter N of the PCI-E device 21, and the second control signal S_AMP is used to adjust an internal amplitude parameter K of the PCI-E device 21. For example, the PCI-E device 21 may include am amplifier 231 (e.g. a differential amplifier) and a reference voltage generator 232. Please refer to FIG. 3, which is a diagram illustrating the amplifier 231 and the reference voltage generator 232 shown in FIG. 2. The amplifier 231 includes a variable load R and a variable bias current source C. The reference voltage generator 232 provides a supply voltage VDD to the amplifier 231. The amplifier 231 has differential output transmission signals TXP, TXN. In this embodiment, the first control signal S_IMP controls the variable load R to adjust the impedance parameter N; the second control signal S_AMP controls the variable bias current source C or the supply voltage VDD to adjust the amplitude parameter K. It should be noted that this is for illustrative purpose only, and not meant to be a limitation of the present invention.

After the internal parameters of the PCI-E device 21 are adjusted, an adjusted characteristic parameter P′ will be sent to the power detection unit 210, and the parameter adjustment unit 220 will compare the adjusted characteristic parameter P′ with the upper bound specified by the EMI specification again. This iteration process will go on until the characteristic parameter P′ is suppressed to its minimum or is less than the upper bound specified by the EMI specification.

For example, in a case where the parameter adjustment unit 220 adjusts the impedance parameter N first, it is assumed that the internal impedance parameter N of the PCI-E device 21 supports a plurality of settings n_min−n_max, wherein n_min is a minimum setting of the impedance parameter N, and n_max is a maximum setting of the impedance parameter N; and the internal amplitude parameter K of the PCI-E device 21 supports a plurality of settings k_min−k_max, wherein k_min is a minimum setting of the amplitude parameter K, and k_max is a maximum setting of the amplitude parameter K. In order to find out an effective parameter setting rapidly, an initial value of the impedance parameter N can be configured to be (n_min+n_max)/2 in the first place; however, this is for illustrative purpose only and not a limitation of the present invention. In the case where N=n and K=k, P(n, k) is representative of the characteristic parameter P detected by the power detection unit 210; where n is representative of the last setting of the impedance parameter N, and n+1 is representative of the current setting of the impedance parameter N. When the parameter adjustment unit 220 adjusts the impedance parameter N, the direction of the adjustment of the impedance parameter N will be considered correct and the adjustment should go on if P (n, k)>P(n+1, k) and P(n+1, k)>the upper bound specified by the EMI specification. Thus the next adjustment will remain the same direction (i.e. the next impedance parameter to be adjusted would be N=n+2). On the contrary, when the parameter adjustment unit 220 adjusts the impedance parameter N, the direction of the adjustment of the impedance parameter N will be considered incorrect and the adjustment should go on with the other direction if P(n, k)<P(n+1, k) and P(n+1, k)>the upper bound specified by the EMI specification. Thus the next adjustment will change the direction (i.e. reverse the current parameter adjustment direction and set the next impedance parameter to be adjusted by N=n). The process will be repeated until the characteristic parameter P of the interference signal detected by the power detection unit 210 is less than the upper bound specified by the EMI specification or is suppressed to its minimum.

In addition, when the parameter adjustment unit 220 has changed the adjustment direction of the impedance parameter N twice or N=n_min or N=n_max, it is regarded that the impedance parameter N has been adjusted to its optimum n′ under the amplitude parameter K=k, so that the characteristic parameter P of the interference signal detected by the power detection unit 210 becomes its minimum. However, if the characteristic parameter P is still greater than the upper bound specified by the EMI specification, the parameter adjustment unit 220 will still need to perform further adjustment upon the amplitude parameter K.

The adjustment of the amplitude parameter K is similar to that of the impedance parameter N. In order to find out an effective parameter setting rapidly, an initial value of the amplitude parameter K can be configured to be (k_min+k_max)/2 in the first place, where k is representative of the last setting of the impedance parameter K, and k+1 is representative of the current setting of the impedance parameter K. When the parameter adjustment unit 220 adjusts the amplitude parameter K, the direction of the adjustment of the amplitude parameter K will be considered correct and the adjustment should go on if P(n′, k)>P(n′, k+1) and P(n′, k+1)>the upper bound specified by the EMI specification. Thus the next adjustment will remain in the same direction (i.e. the next amplitude parameter to be adjusted would be K=k+2). On the contrary, when the parameter adjustment unit 220 adjusts the amplitude parameter K, the direction of the adjustment of the amplitude parameter K will be considered incorrect and the adjustment should go in the other direction if P(n′, k)<P(n′, k+1) and P(n′, k+1)>the upper bound specified by the EMI specification. Thus the next adjustment will change the direction (i.e. reverse the current parameter adjustment direction and set the next impedance parameter to be adjusted by K=k). The process will be repeated until the characteristic parameter P of the interference signal detected by the power detection unit 210 is less than the upper bound specified by the EMI specification or is suppressed to its minimum. When the parameter adjustment unit 220 has changed the adjustment direction of the amplitude parameter K twice or K=k_min or K=k_max, it is regarded that the amplitude parameter K has been adjusted to its optimum k′, so that the characteristic parameter P of the interference signal detected by the power detection unit 210 becomes its minimum or less than the upper bound specified by the EMI specification.

Please note that, in order to effectively and rapidly determine the parameter setting, the exhaustion search of each amplitude parameter K and each impedance parameter N is abandoned in this embodiment. Hence, a found combination of parameters may not be the optimal parameter combination that makes the characteristic parameter P reach its minimum. Instead, the found combination of parameters is merely a certain parameter setting which makes the characteristic parameter P less than the upper bound specified by the EMI specification. However, this is for illustrative purpose only, and not meant to be a limitation of the present invention.

Similarly, in order to find out an effective parameter setting, an initial value of the amplitude parameter K can be configured to be (k_min+k_max)/2 in the first place, and then the adjustment is applied to the impedance parameter N. Assume that k is the value of the last setting of the amplitude parameter K, n′ is representative of the optimal impedance parameter under K=k, k+1 is representative of the current setting of the amplitude parameter K, and n″ is representative of the optimal impedance parameter under K=k+1. When the parameter adjustment unit 220 adjusts the impedance parameter K, the direction of the adjustment of the impedance parameter K will be considered correct and the adjustment should go on if P(n′, k)>P(n″, k+1) and P(n″, k+1)>the upper bound specified by the EMI specification. Thus the next adjustment will remain in the same direction (i.e. the next impedance parameter to be adjusted would be K=k+2). On the contrary, when the parameter adjustment unit 220 adjusts the impedance parameter K, the direction of the adjustment of the impedance parameter K will be considered incorrect and the adjustment should go in the other direction if P(n′, k)<P(n″, k+1) and P(n″, k+1)>the upper bound specified by the EMI specification. Thus the next adjustment will change the direction (i.e. reverse the current parameter adjustment direction and set the next impedance parameter to be adjusted by K=k). The process will be repeated until the characteristic parameter P of the interference signal detected by the power detection unit 210 is less than the upper bound specified by the EMI specification or is suppressed to its minimum. When the parameter adjustment unit 220 has changed the adjustment direction of the amplitude parameter K twice or K=k_min or K=k_max, it is regarded that the amplitude parameter K has been adjusted to its optimum k′, so that the characteristic parameter P of the interference signal detected by the power detection unit 210 becomes its minimum.

It should be noted that the above mentioned embodiments are for illustrative purpose only and not a limitation of the present invention. Those skilled in the art should readily understand that the adjustment order of the impedance parameter N and the amplitude parameter K may be altered to find out the appropriate settings of the impedance parameter N and the amplitude parameter K which leads to reduced interference signal. This alternative design also falls within the scope of the present invention.

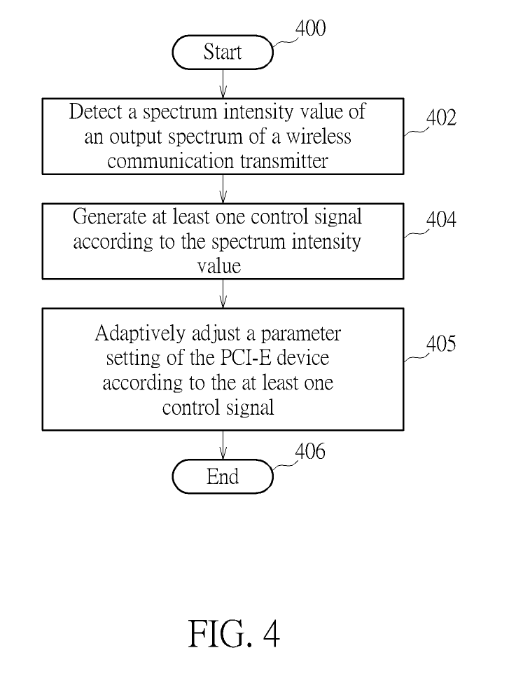

Please refer to FIG. 4, which is a flowchart illustrating a control method for a PCI-E device according to an embodiment of the present invention. Provided that substantially the same result is achieved, the steps in FIG. 4 need not be in the exact order shown and need not be contiguous; that is, other steps can be intermediate. Some steps in FIG. 4 may be omitted according to various types of embodiments or requirements. The control method comprises the following steps:

Step 400: start;

Step 402: detect a spectrum intensity value of an output spectrum of a wireless communication transmitter;

Step 404: generate at least one control signal according to the spectrum intensity value;

Step 405: adaptively adjust a parameter setting of the PCI-E device according to the at least one control signal; and

Step 406: end.

Since those skilled in the art should readily understand the operational details of steps shown in FIG. 4 after reading the paragraphs associated with the control circuit 200 of the PCI-E device 21, the details are omitted here for brevity.

In summary, the present invention provides a control circuit and an associated control method which reduce the interference introduced to the wireless communication by a PCI-E device without degrading the transmission quality of the PCI-E.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control circuit for a peripheral component interconnect express (PCI-E) device, comprising:
a power detection unit, coupled to a wireless communication transmitter, the power detection unit arranged for detecting a spectrum intensity value of an output spectrum of the wireless communication transmitter; and
a parameter adjustment unit, coupled to the power detection unit, the parameter adjustment unit arranged for generating at least one control signal according to the spectrum intensity value, and adaptively adjusting a parameter setting of the PCI-E device according to the at least one control signal.

2. The control circuit of claim 1, wherein the power detection unit comprises:
a mixer, arranged for down converting an interference signal to be detected in the output spectrum; and
a power detector, coupled to the mixer, the power detector arranged for detecting the down converted interference signal, so as to generate the spectrum intensity value.

3. The control circuit of claim 1, wherein the at least one control signal comprises an impedance adjustment signal, and the impedance adjustment signal is outputted to the PCI-E device to adjust impedance of the PCI-E device.

4. The control circuit of claim 3, wherein the PCI-E device comprises an amplifier having a variable load; and the impedance adjustment signal is utilized to adjust the variable load.

5. The control circuit of claim 1, wherein the at least one control signal comprises an amplitude adjustment signal, and the amplitude adjustment signal is outputted to the PCI-E device to adjust amplitude of transmission signals of the PCI-E device.

6. The control circuit of claim 5, wherein the PCI-E device comprises an amplifier having a variable bias current source; and the amplitude adjustment signal is utilized to adjust the variable bias current source.

7. The control circuit of claim 1, wherein the PCI-E device comprises an amplifier and a reference voltage generator, the reference voltage generator is utilized for providing a supply voltage to the amplifier; and the amplitude adjustment signal is utilized to adjust the supply voltage.

8. The control circuit of claim 1, wherein the parameter adjustment unit ceaselessly adjusts the parameter setting of the PCI-E device until it is detected that the spectrum intensity value is less than a predetermined threshold.

9. The control circuit of claim 1, wherein the wireless communication is a wireless fidelity (Wi-Fi) transmitter.

10. The control circuit of claim 1, wherein the wireless communication is a Bluetooth (BT) transmitter.

11. A control method for a peripheral component interconnect express (PCI-E) device, comprising the steps of:
detecting a spectrum intensity value of an output spectrum of the wireless communication transmitter; and
generating at least one control signal according to the spectrum intensity value, and adaptively adjusting a parameter setting of the PCI-E device according to the at least one control signal.

12. The control method of claim 11, wherein the detecting step comprises:
down converting an interference signal to be detected in the output spectrum; and
detecting the down converted interference signal, so as to generate the spectrum intensity value.

13. The control method of claim 11, wherein the parameter adjustment unit ceaselessly adjusts the parameter setting of the PCI-E device until it is detected that the spectrum intensity value is less than a predetermined threshold.

14. The control method of claim 11, wherein the wireless communication is a wireless fidelity (Wi-Fi) transmitter.

15. The control method of claim 11, wherein the wireless communication is a Bluetooth (BT) transmitter.
